(19) United States
(12) Patent Application Publication
(10) Pub. No.: US 2004/0136079 A1
(43) Pub. Date: Jul. 15, 2004

(54) Lenticular lens pattern-forming device for producing a web roll of lenticular lens

(75) Inventor: Timothy P. Goggins, Nashotah, WI (US)

Correspondence Address: WHYTE HIRSCHBOECK DUDEK S C, 555 EAST WELLS STREET, SUITE 1900, MILWAUKEE, WI, 53202, US

(73) Assignee: National Graphics, Inc., Brookfield, WI

(21) Appl. No.: 10/340,075

(22) Filed: Jan. 10, 2003

(51) Int. Cl. G02B 27/10; B29D 11/00

(52) U.S. Cl. 359/619; 264/1.6; 359/621; 425/808; 425/363

(57) ABSTRACT

The present invention provides a lenticular lens and method for manufacturing the lens, and in particular when the lens is a lenticular lens web, such that finishing operations (e.g., cutting, laminating, etc.) and various end-use applications of the lens (e.g., labeling) can be achieved or accommodated in-line with the manufacture of the lens web. A lenticular pattern-forming device comprising a housing that is rotatable about a central longitudinal axis is disclosed. The housing has an outer surface having a groove pattern. The groove pattern includes circumferentially and longitudinally extending grooves on the outer surface and the grooves have substantially equal groove widths. The longitudinally extending grooves are substantially parallel with the central longitudinal axis and grooves cover the outer surface of the housing. In addition, the invention further includes a method of using the lenticular pattern-forming device to produce a lenticular lens web, which can be used to make a lenticular image web. The image web can be used to create end products such as wallpaper, banners, labels and the like.

### FIELD OF THE INVENTION

This invention relates generally to lenticular lenses and, more particularly, to a device, system, and method for making lenticular lenses.

### BACKGROUND OF THE INVENTION

Lenticular lenses take the form of a transparent plastic sheet or web, and the sheet typically includes an array of identical curved or ribbed surfaces (i.e., a lenticular lens pattern) that are formed (e.g., cast, coated, embossed, extruded, or co-extruded) on the front surface of the plastic sheet. The back surface of the lens is typically flat. Each lenticule or individual lens is a section of a long cylinder that focuses on, and extends over, substantially the full length of an underlying image. Other lens shapes or profiles are possible (for instance, pyramidal, trapezoidal, parabolic, and the like). The lenticular lens is generally selected to accommodate both the underlying image and the distance from which the image will ordinarily be viewed by a viewer. Various types of lenticular lenses are commercially available.

A lenticular image comprises an underlying interlaced precursor image that can be joined to a lenticular lens in any of a variety of alternative ways (described further below). The preparation of the interlaced precursor image is well known in the art. The precursor image is a composite of two or more component images that are themselves preferably of photographic quality. The component images are selected based upon the desired features of the lenticular or final image. The component images are then arranged, segmented, interlaced and mapped to create the precursor image so that the precursor image corresponds with the lenticular lens to which it will be joined.

In the past, to perceive the desired visual effect (e.g., motion and/or depth), the interlaced image was typically printed to a substrate (e.g., paper, plastic, metal, glass or wood). Then the substrate bearing the image was usually laminated to the lenticular lens (i.e., thereby creating the lenticular image). Such lamination typically required the application of an adhesive layer (i.e., to the lens sheet, to the substrate layer, or both). The adhesive, unfortunately, can deleteriously affect the optical properties of the image when viewed through the lens. In addition, lamination requires the extra and often costly step of joining the two layers to one another.

Today, lenticular technology is in use on a variety of items, such as: promotional buttons, magnets, coasters, collectibles, display posters, signs, menu boards, postcards and business cards. Lenticular technology is also used in packaging, publishing and labeling applications. Such applications often include areas that contain small fonts and/or fine seraphs having type sizes, on the order of about nine (9) points or less. Warning labels, ingredient labels or listings, and ownership or attribution markings (e.g., “Copyright, 2001 National Graphics, Inc., All Rights Reserved”), and the like are instances where small type size is common. In addition, bar code labels comprising lines and spaces between the lines have also proven difficult to resolve. As used herein, “resolve” means to make visible and distinguish parts of an image, for instance, the image segments of an interlaced image. Issues like these have posed problems for those attempting to use lenticular technology in conjunction with packaging, publishing, labeling and other applications.

Manufacturing lenticular lenses is a highly specialized process. For example, a resin material can be extruded onto a transparent pre-produced sheet or web (i.e., a film), and the lenticular lens pattern embossed into the resin by an embossing roll. More commonly, lenticular lens is made using a machine or system which includes an extruder and a plurality of longitudinally stacked rollers that are used to move and support the plastic sheet. In the typical scenario, three stack rollers are used, two of which are positioned one over the other, with the third roller disposed in between the first two rollers. In this case, the first or upper roller and the second or lower roller usually have smooth outer surfaces. The middle roller is usually a lenticular pattern-forming device (e.g., an engraved cylinder) which includes a groove pattern on its outer surface. When a plastic sheet or film is pressed against the groove pattern, a plurality of lenticular lenses or lenticules, which make up a lenticular pattern, are formed on a surface of the plastic sheet. In this way, a lenticular pattern is formed in the sheet or web that corresponds to the groove pattern. Therefore, to produce a high quality lenticular lens, it is necessary to design and fabricate an arcuate, high quality lenticular pattern-forming device.

Existing designs provide for a variety of lenticular pattern-forming devices. One typical lenticular pattern-forming device is an engraved cylinder that includes circumferentially extending grooves that are formed on the outer surface of the cylinder. The grooves can be configured such that they are parallel or transverse with the longitudinal axis of the cylinder. Each groove is sized to emboss a respective lenticule to form a lenticular pattern, and ultimately a lenticular lens sheet or web.

However, there are drawbacks with existing designs, as shown in FIGS. 1a-b and 2a-b. For instance, as shown in FIG. 1a, a lenticular pattern-forming device 100, such as an engraved cylinder, is shown. Pattern-forming device 100 includes grooves, collectively referred to by the numeral 102. As shown, grooves 102a-b are separated by what can be termed to be “non-lenticular pattern-forming region,” indicated by the numeral 104. In FIG. 1a, the non-lenticular pattern-forming region takes the form of a flat ridge, although this is only exemplary. The region can also take the form of a raised region, bump or other irregularity formed in the surface of the lenticular pattern-forming device. Each of the grooves is shown to have a width “w” as shown.

FIG. 1b illustrates a lenticular image 106, the image including a lenticular lens 108 produced by the pattern-forming device 100 of FIG. 1a. The lenticular lens 108 includes a plurality of lenticules, collectively referred to by the numeral 110, located opposite a substantially flat backside 112. Each of the lenticules has a width “w” as shown. A precursor image 114 is joined to the flat backside 112 so as to create lenticular image 106. As shown, the precursor image 114 is an interlaced image that can impart the illusion of motion and/or depth to an observer when it is viewed through lenticular lens 108.

In order to impart the illusion of depth and/or motion, the interlaced image is made from more than one picture or frame. Typically, four pictures are interlaced with one another in any desired sequence to form a composite image or picture that when viewed through the lenticular lens, imparts the illusion of depth and/or motion to the viewer. In order to impart the illusion of depth and/or motion to the viewer, the interlaced image must be “in phase”, or correspond with, the lenticules of the lens.

Still referring to FIG. 1b, interlaced image 106 includes segments a-e and lenticular lens 108 includes lenticules L₁ to L₅. Lenticular lens 108 also includes non-lenticular region 116 created by non-lenticular pattern-forming region 104 (FIG. 1a). Lenticules L₁₋₃ of lenticular lens 108 are aligned, and therefore are in correspondence, with segments a-c of the interlaced image, respectively, and therefore the images segments a-c are “in phase” with the lenticules L₁₋₃. In contrast, the lenticules L₄ and L₅ are not aligned, and therefore are not in correspondence, with segments d and e of the interlaced image, respectively, because lenticules L₃ and L₄ are separated by non-lenticular region 116. The non-lenticular region results in the interlaced image being “out of phase” with respect to lenticular lens 108.

Turning to FIG. 2a, a lenticular pattern-forming device 120, such as an engraved cylinder, is shown. Here again, pattern-forming device 120 includes grooves, collectively referred to by the numeral 122. As shown, grooves 122a-b are separated by what can be termed to be “truncated lenticular pattern-forming region,” indicated by the numeral 124. In FIG. 2a, the truncated lenticular pattern-forming region has a profile that resembles a “w”, although this is only exemplary. In general, the profile of such a region will correlate with the profile of grooves that are intended to be, but are not completely, formed in the pattern-forming device. Again, each of the grooves is shown to a width “w” as shown.

FIG. 2b illustrates lenticular image 130, the image including a lenticular lens 132 produced by the pattern-forming device 120 (FIG. 2a). The lenticular lens 132 includes a plurality of lenticules, collectively referred to by the numeral 134, located opposite a substantially flat backside 136. As shown, each of the lenticules has a width “w” corresponding to the width of the grooves of the pattern-forming device. A precursor image 138, such as an interlaced image, is joined to the flat backside 136 so as to create lenticular image 130. Interlaced image 138 includes segments a-e and lenticular lens 132 includes lenticules L₁ to L₄. Lenticular lens 132 also includes truncated lenticular region 140 created by truncated lenticular pattern-forming region 124 (FIG. 2a). Lenticules L₁₋₃ of lenticular lens 132, are aligned, and therefore are in correspondence, with segments a-c of the interlaced image, respectively, and therefore the image segments a-c are “in phase” with the lenticules L₁₋₃. In contrast, the lenticules L₄ is not aligned, and therefore are not in correspondence, with segments d or e of the interlaced image because lenticules L₃₋₄ are separated by truncated lenticular region 140. In general, the truncated lenticular region results in the interlaced image being “out of phase” with respect to lenticular lens 14.

Thus, in general, a non-continuous lenticular pattern (e.g., resulting from the non lenticular or truncated lenticular regions) results when lenticular lenses are manufactured using current lenticular pattern forming devices having groove patterns as shown in FIGS. 1a-b. As a result, the production and usefulness of long continuous webs of uniform lenticular lens material is severely limited. For example, a lens web often must be cut into discrete sections such that the sections are free from any non-lenticular or truncated lenticular regions. Such a process is costly, time consuming, and significantly reduces the efficiency of producing a web of lenticular lens material in large volume. Alternatively, an underlying image that is to be joined to the lenticular lens having a non-lenticular or truncated lenticular pattern must be adjusted or otherwise manipulated so as to achieve correspondence with the lens. Such manipulation is difficult and time-consuming at best, and in many cases, may be virtually impossible.

It would be desirable if a lenticular lens could be created in web format such that finishing operations (e.g., cutting, laminating, etc.) and various end-use applications of the lens (e.g., labeling) could be achieved or accommodated in-line with the manufacture of the lens web.

Therefore, there is a need to improve the design of the lenticular pattern-forming devices, such as engraved cylinders, so that non-lenticular or truncated lenticular pattern-forming regions are eliminated from the surface of the device, thereby eliminating or substantially eliminating any non-continuous lenticular patterns that may formed as a result therefrom. Ideally, the improved device can be used to produce a lenticular lens, particularly when the lens is in web form, such that the lens is suitable for creating a lenticular image in which correspondence is achieved between the lens and the image.

### SUMMARY OF THE INVENTION

Disclosed herein is a lenticular pattern-forming device comprising: a housing rotatable about a central longitudinal axis, the housing including an outer surface having a groove pattern, the groove pattern including longitudinally extending grooves on the outer surface of the housing, the grooves having substantially equal groove widths, the grooves oriented substantially parallel with the central longitudinal axis. Significantly, the grooves cover the outer surface of the housing.

In one preferred embodiment, the outer surface of the housing does not include a non-lenticular pattern-forming region. In another preferred embodiment, the outer surface of the housing does not include a truncated lenticular pattern-forming region.

Methods, systems and products incorporated and made according to the present invention are also disclosed herein.

### BRIEF DESCRIPTION OF THE DRAWINGS

The drawings illustrate the best mode presently contemplated for carrying out the invention.

In the drawings:

FIG. 1a is a partial perspective view of a lenticular pattern-forming device illustrating a non-lenticular pattern-forming region;

FIG. 1b is a sectional view of a portion of a lenticular image made by the lenticular pattern-forming device of FIG. 1a illustrating a non-lenticular region.

FIG. 2a is a partial perspective view of a lenticular pattern-forming device illustrating a truncated lenticular pattern-forming region;

FIG. 2b is a sectional view of a portion of a lenticular image made by the lenticular pattern-forming device of FIG. 1a illustrating a truncated lenticular region.

FIG. 3 is a perspective view of a system having a lenticular pattern-forming device for making a web roll of lenticular lens material in accordance with the present invention;

FIG. 4 is a reverse perspective view of a portion of FIG. 3;

FIG. 5 is a partial perspective view of the lenticular pattern-forming device in accordance with the present invention;

FIG. 6 is a cross sectional view of the lenticular pattern-forming device taken along line 6-6 of FIG. 5;

FIG. 7 is an enlarged portion of the lenticular pattern-forming device of taken along line 7-7 of FIG. 6;

FIG. 8 is a sectional view of a portion of a lenticular image made by using the lenticular pattern-forming device of FIG. 5;

FIG. 9 is a schematic illustration of a lenticular lens web formed using the system of the present invention; and

FIG. 10 is a schematic illustration of one example of a representative lenticular image web formed using the lenticular lens web of FIG. 9.

### DETAILED DESCRIPTION OF THE INVENTION

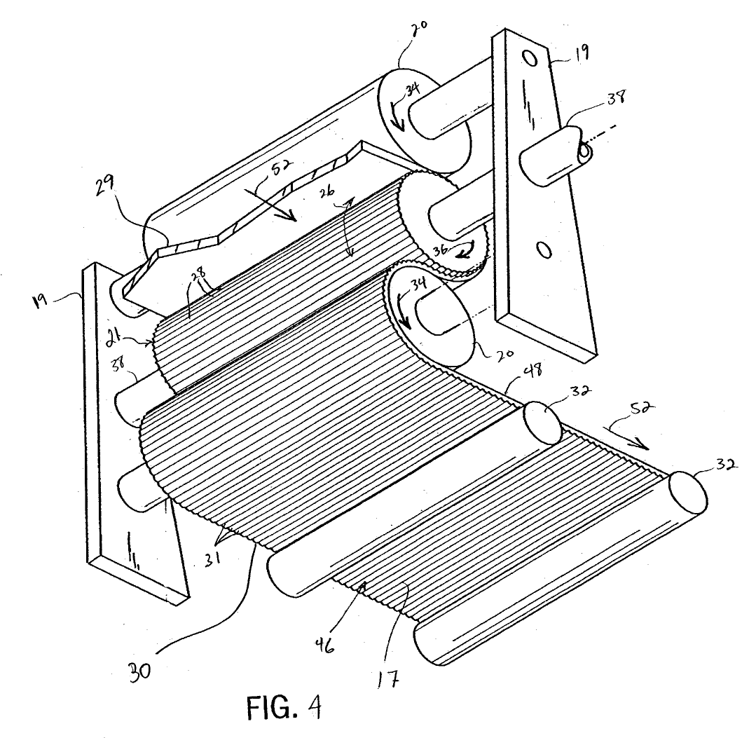

FIGS. 3 and 4 show system 10 for making an elongated, continuous web of lenticular lens 30. Lenticular lens web 30 can be rolled into a continuous web roll 40. Lenticular pattern-forming device 21, which is used to make lenticular lens web 30, is briefly described here, but the detailed design of device 21 will be described in greater detail below. System 10 includes frame 19 to support lenticular device 21. The system further includes a pair of nip rollers 20 mounted on frame 19. The lenticular device 21 comprises a housing 22 having an outer surface 24. The outer surface 24 includes a groove pattern 26 that is preferably engraved circumferentially therein. In other words, the groove pattern 26 extends around the circumference of the outer surface 24. The grooves 28 make up the groove pattern 26 which extends in parallel fashion along the outer surface of the cylinder. The housing 22 is longitudinally disposed between the nip rollers 20 to define a nip or gap between the cylinder and the nip rollers 20. A transparent layer 29 of plastic material is passed through the nip/gap such that the plurality of the pattern-forming grooves 26 contact the layer of plastic material and emerges as lenticular lens web 30.

The system 10 further includes tensioning rollers 32 to control and adjust pressure applied to the lenticular lens web 30. Electric motors or adjustable drives (not shown) are provided to rotate the rollers. The pair of nip rollers 20 applies pressure to press or force the lenticular lens web 30 against the plurality of pattern-forming grooves 26. The nip rollers 20 rotate in a first direction indicated by arrow 34 and the cylindrical housing rotates in opposite second direction indicated by arrow 36 with respect to the nip rollers 20. The conveyor belt (not shown) travels in a direction indicated by arrow 52, which corresponds to the direction of travel of the lenticular lens web, as a result of friction with the tensioning rollers 32. The cylindrical housing 22 is mounted on frame 19 via a tubular body 38. Extruder 40 is used to heat a resin into a high temperature molten resin that form into the plastic layer 29. The heated plastic layer 29 is then passed along to the pattern-forming grooves 26 on the outer surface 24 of the cylinder 22. After passing along the grooves, plastic layer 29 becomes lenticular lens web 30. The lens web 30 is then cooled so as to solidify lenticular pattern 31 in lens web 30. Cooling fluid circulates through the tubular body 38 to substantially cool the lens web 30 passing over the lenticular pattern-forming device (e.g., an engraved cylinder) 16. The cooling fluid may be a liquid, such as water, or may be gas (e.g., air) as would be readily appreciated by those skilled in the art. The cooling fluid is supplied by a heat exchanger referenced schematically by numeral 54 as depicted in FIG. 3.

As shown in FIGS. 3 and 4, the continuous lenticular lens web 30 is created and wound so as to form a continuous lenticular lens web roll 14. The long plastic layer is typically wound on a shaft (not shown) to create the roll. The plastic layer includes a front surface 46 and a substantially flat back surface 48 opposing the front surface. The front surface has a plurality of lenticules 49 formed thereon. Advantageously, when the plurality of lenticules 49 is made using the lenticular pattern-forming device 21 and is wound to create web roll 14, the plurality of lenticules 49 are configured to be substantially parallel with a central longitudinal axis 50 of the web roll 14. Stated another way, the lenticules 49 are created using the lenticular pattern-forming device 21 such that they are oriented to be perpendicular to the direction of travel 52 of the lenticular lens web 30.

Although plastic is a common material used for producing a web roll 14, other non-plastic material such as fiberglass can be used, depending on the particular application. The plastic web roll 14 material is preferably selected from the following: polyester, vinyl, polycarbonate, polyvinyl chloride, polyethylene terephthalate, and amorphous polyethylene terephthylene, although other materials are contemplated and within the scope of the present invention. Because of elastic nature of the plastic material, the lens web 30 tends to resist manipulation (e.g., bending, twisting, forming, etc.) that can be required for a particular application. Thick lenticular lens material tends to return to its original shape after tension due to manipulation has been released. For example, a curled plastic lenticular sheet, once flattened or straightened, tends to curl when not fixed in place. In other words, many plastics tend to have a “memory”, and the thicker the plastic, the greater the memory. Moreover, the greater the memory, the greater the difficulty in manipulating the plastic, for instance, bending the lenticular lens around a package corner, or around a curved application, such as a cup. Thicker lenses require more plastic material and, therefore they are usually more expensive to manufacture. In fact, it has been found that perhaps about one third of the cost of current lenticular printing can be attributed to the cost of the lenticular plastic itself.

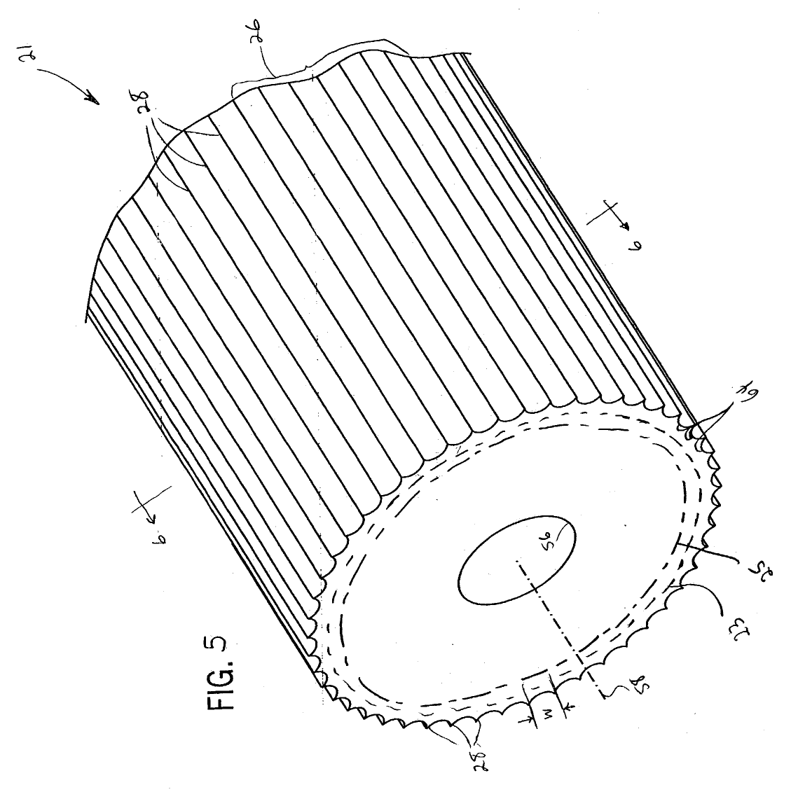

FIG. 5 is a perspective view of a lenticular pattern-forming device 21 according to the present invention. In a preferred embodiment, the lenticular device 21 is an engraved from a cylinder (not shown). The device includes a groove pattern 26 disposed around the circumference of the device. The device 21 preferably comprises a nickel-phosphorous material. The pattern-forming device 21 also includes an inner surface 56 to receive the tubular body 38 as described above. The inner surface 56 of the device has a predetermined diameter to frictionally engage with the tubular body 38 (shown in FIGS. 3 & 4).

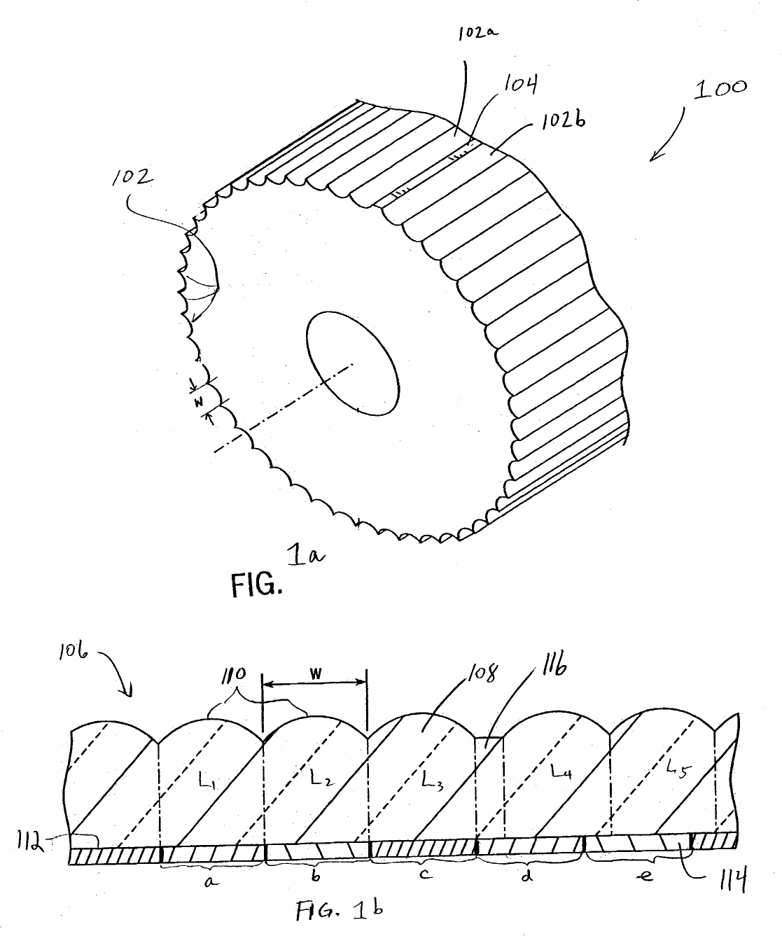

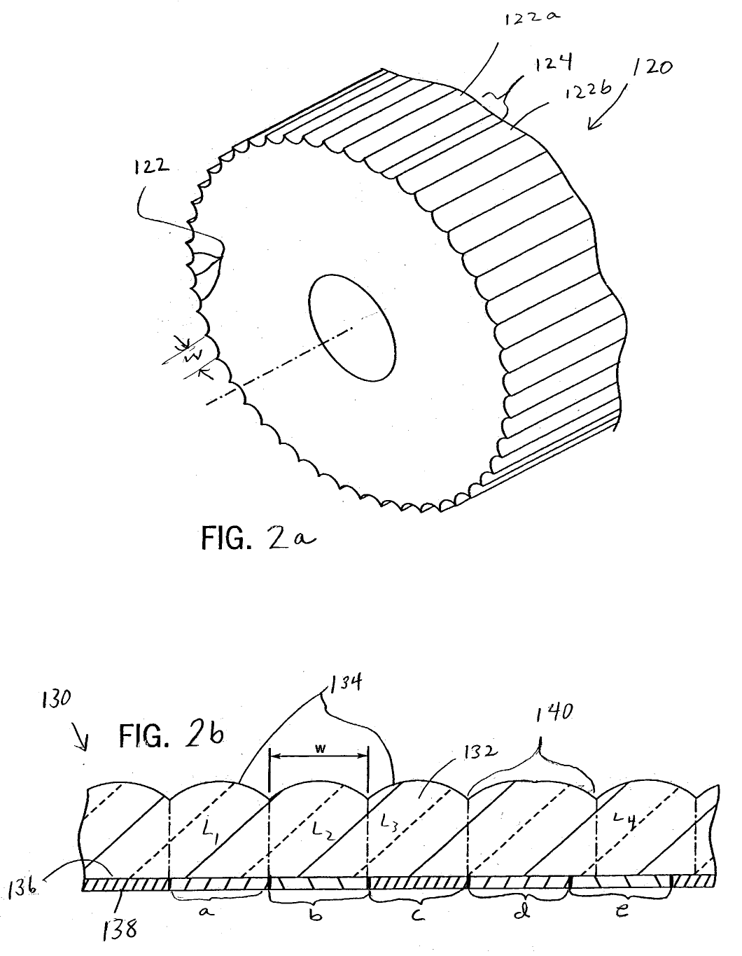

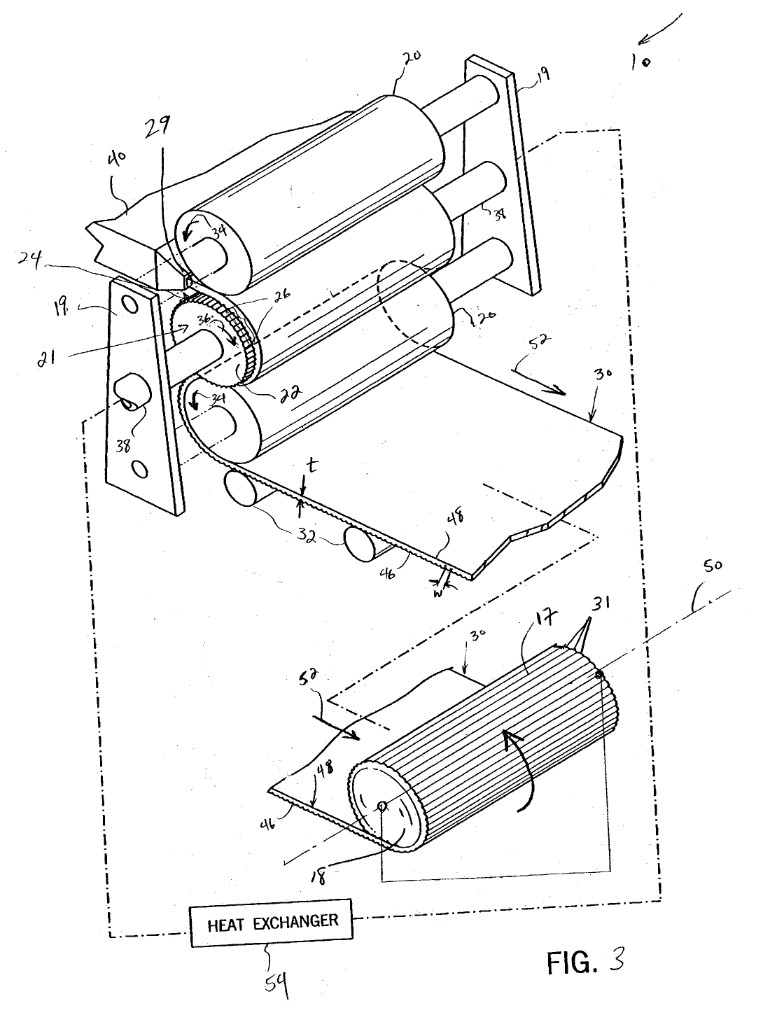

Alternatively, the lenticular pattern-forming device can include an enclosure, schematically illustrated via dashed lines 23, that is rotatable about the central longitudinal axis. In yet another embodiment, the lenticular pattern-forming device can include a molding sleeve, schematically illustrated by second set of dashed lines 25, slidably positioned on the tubular body 38 (shown in FIGS. 1 & 2). The molding sleeve may be fabricated using a nickel-phosphorous alloy on a mandrel (not shown), and more specifically, by electro-depositing a required thickness of nickel-phosphorous alloy, and then cutting the groove pattern 26 into the outer surface 24, for example, with a diamond cutter.

In a preferred embodiment, the plurality of longitudinally extending grooves 28 are arranged to be substantially parallel with the central longitudinal axis 58 of the pattern-forming device. The grooves 28 preferably have an arcuate cross sectional surface 60. The grooves 28 are engraved so as to ultimately produce lenticular lens in accordance with a given lens per inch (LPI) designation or pitch of the lenticular material. It is typical in lenticular industry to use a lenticular lens having 75 lenticules per inch. However, it is contemplated that the lenticular pattern-forming device of the present invention can be used to make a wide variety of lenticular lens types including high definition lens described below in greater detail. Each groove 28 has a constant internal radius of curvature 64. Notably, the lenticular pattern-forming device is designed such that sum of the plurality of groove widths (W) is equal to or substantially equal to the circumference of the cylinder from which the lenticular pattern-forming device is made. The grooves 28 are designed to cover the entire circumference of the housing. Each groove 28 corresponds to form a lenticule formed on the plastic layer 30.

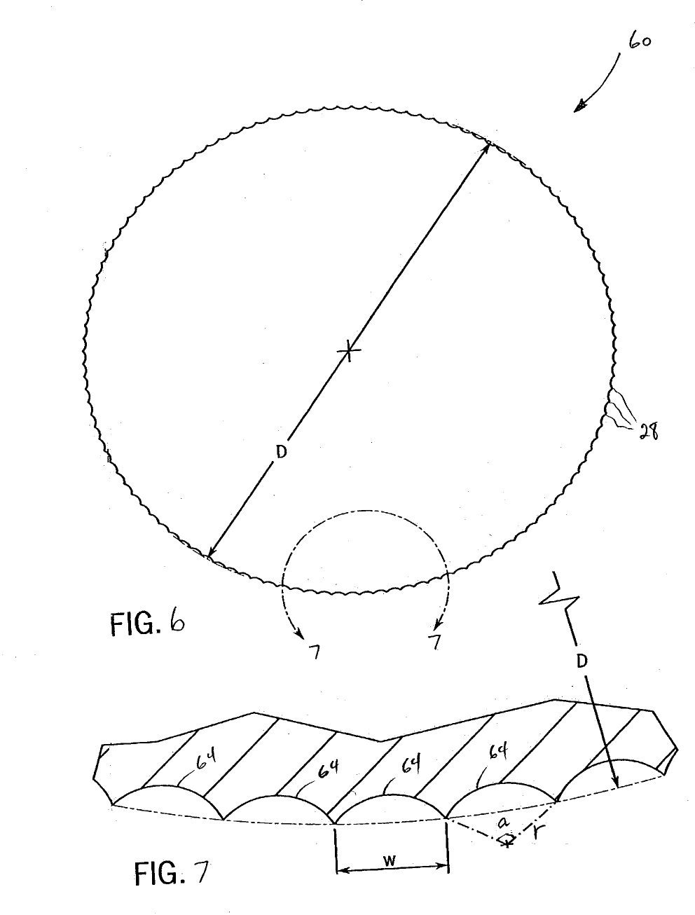

FIG. 6 is cross sectional view of FIG. 5, which illustrates that wherein the grooves cover the outer surface of the housing of the lenticular pattern-forming device. More preferably, the grooves completely cover the outer surface. Each of the grooves 28 has a predetermined radius of curvature 62. Each groove width (W) is a function of both the arc angle (a) and the radius (r) of that particular groove as depicted in FIG. 7. It should be noted that number of grooves 28 depends on the diameter of the lenticular pattern-forming device (e.g., engraved cylinder) 16. For example, for a groove width of 0.0066 inches on a lenticular pattern-forming device having an 18 inch diameter, design calculations (i.e., an iterative process) show that there will be 8,568 grooves in order to cover the entire or substantially the entire surface of the device. Accordingly, for a given groove width, the number of grooves needed to cover the entire circumference of the cylinder increases as diameter of the cylinder increases. The mathematical relationships between various parameters (i.e., circumference of the cylinder, width and number of lenticules) as described above have been determined according to the following equations:

C=πD; and (1)

Lᵢ=C/W; (2)

where “C” and “D” are the circumference and the diameter of the device, respectively, and Lᵢ and W are the number of lenticules and the width of each lenticule, respectively.

To design a particular cylinder, certain parameters for the cylinder are typically set or predetermined (such as radius, arc length, or number of grooves). For example, using the above formulae (1) and (2), calculation shows that for an 18 inches cylinder diameter and a groove width of 0.005 inches (which corresponds to 200 LPI), the total number of grooves is 11,309.6. Because each groove forms exactly one lenticule on the plastic layer, the total number of grooves can be rounded up to obtain a whole number of grooves, namely 111,310 grooves, provided that this rounding is taken into account. In the preferred embodiment, the value for the total number of grooves can be truncated, again assuming the truncation is taken into account. Using an iterative numerical calculation, the whole number of 11,310 is substituted back into the formula (2) and a new groove width value (i.e., 0.004999 inches) inch for the width of lenticule is obtained. The new value is desired or actual width of the groove and in this case is less than the theoretical or approximated value (i.e., 0.005 inches). Accounting for difference between the actual or theoretical values of the grooves is the principal cause of a non-lenticular pattern-forming region or a truncated lenticular pattern-forming region resulting on the circumference of engraved cylinder. The present invention provides for a substantial reduction in the margin of error between the actual and theoretical values for the width of the grooves. In a table below, the actual and theoretical values for the groove width and the total number of grooves are calculated for various cylinder sizes and theoretical groove widths.

| | Width | | | |
|---|---|---|---|---|
| Diameter | Theoretical | Actual | Number of Groove | |
| (in) | (in) | (in) | Theoretical | Actual |
| 12″ | 0.0033 | 0.003299 | 11,423.97 | 11,424 |
| | 0.005 | 0.004999 | 7539.82 | 7,540 |
| | 0.0066 | 0.006599 | 5711.97 | 5712 |
| 18″ | 0.0033 | 0.003299 | 17,135.96 | 17,136 |
| | 0.005 | 0.004999 | 11,309.73 | 11,310 |
| | 0.0066 | 0.006599 | 8567.98 | 8568 |
| 24″ | 0.0033 | 0.003299 | 22,847.94 | 22,848 |
| | 0.005 | 0.004999 | 15,079.64 | 15,080 |
| | 0.0066 | 0.006599 | 11,423.97 | 11,424 |

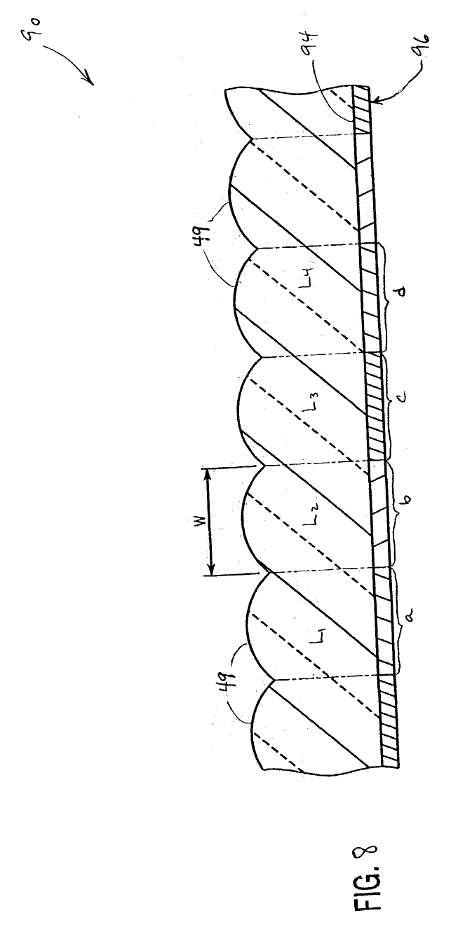

FIG. 8 illustrates a lenticular lens 90 produced by the lenticular pattern-forming device 16. While the lenticular lens 90 is similar in appearance to the lenticular lens 80 depicted in FIG. 4, it can be seen that the lenticular lens 90 is free from any non-lenticular lens region 72, as shown in FIGS. 7 and 8. Notably, The lenticular lens 90 includes a plurality of lenticules 49 (i.e., each lenticule identical to another) opposite substantially flat backside 94. Image 96 is printed directly to the flat back surface 48 of the lenticular lens. Preferably, the lenticules 49 are produced to have a thickness (t) that is substantially equal to the focal length of the lens so as to achieve a focused image. The lens thickness (t) is preferably less than about 10 mils and has a width of 0.00667 inches Thus, in the preferred embodiment, the lens can be characterized as a high definition lens. The high definition lens is of high resolution and has an arc angle of greater than 90 degrees. Significantly, the thinner the gauge or thickness, the more critical it is to ensure that the lens is produced within a desirable tolerance level. The thickness (t) of a lenticules 49 is typically the thickness as measured from the outer most edge of the curved surface of the lens to the flat back surface. One example of a high definition lens is described in greater detail in U.S. Pat. No. 6,424,467 by the inventor of the present invention. As shown in FIG. 8, each of the lenticules L₁, L₂, L₃, and L₄ is respectively in phase with each segments (a), (b), (c), and (d) of interlaced image and the lenticules are not separated by any non lenticular region, such as any flat ridges or other irregularities.

The width of the groove is an important factor in fabrication of the lenticular pattern-forming device. As mentioned above, each groove forms a lenticular lens on the plastic layer or the substrate. Lenticular lenses having widths on the order of 0.01333 inches are considered to be coarse in their resolution and as such, they can not resolve small print. Rather, resolving small type/font sizes requires a more “fine” lens resolution, namely, lenses having lenticules with widths on the order of about 0.006667 inches, more preferably about 0.005000 inches, and most preferably about 0.003333 inches or less. Such lenses are termed “high resolution” lenses.

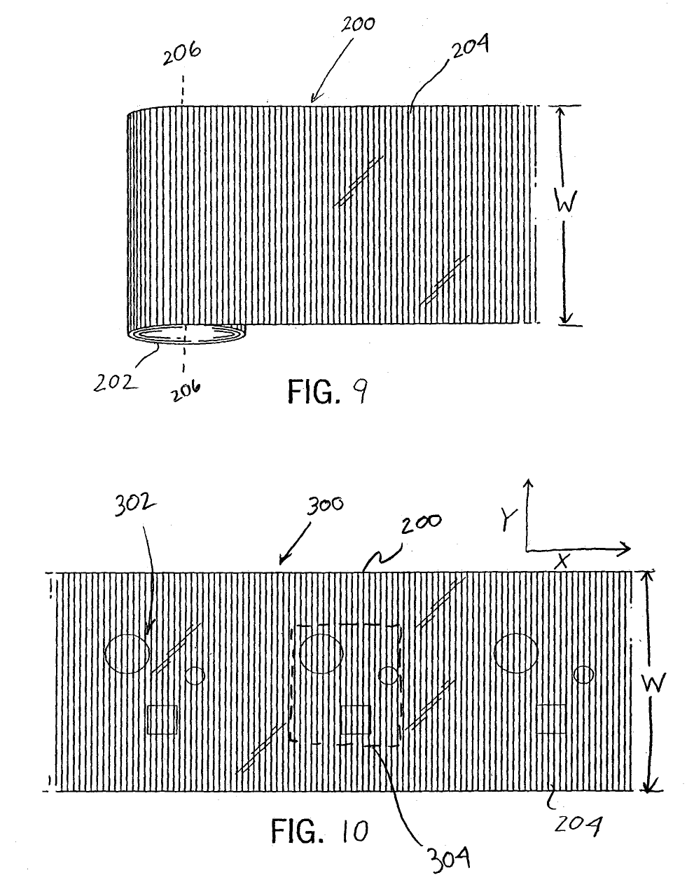

Referring to FIG. 9, a schematic illustration of a lenticular lens web 200 is shown. The lens web 200 is representative of a product made according to and using the present invention. Lens web 200 can be rolled into web roll 202, which facilitates transport and storage of the lens web. Lens web 200 is shown prior to any undergoing any finishing operations (e.g., cutting, laminating, etc.) or various end-use applications of the lens web (e.g., labeling). Advantageously, using lens web 200, such operations or applications can be achieved or accommodated in-line with the manufacture of the lens web itself. Lenticules 204 are oriented such that they are parallel with a central longitudinal axis 206 of the web roll 202. As shown, each of the lenticules has a length that is equal to the width W of the overall lens web 200. Lens web 200, more particularly the front surface, is free from any non-lenticular or truncated lenticular regions, while the length of the lens web can include any desired number of lenticules.

FIG. 10 is a schematic illustration of one example of a representative lenticular image web 300. Image web 300 is formed using lenticular lens web 200 of FIG. 9. An interlaced image 302 is joined to lens web 200 to create the image web 300. Interlaced image 302 includes repeating interlaced image element 304. In defining the orientation of lenticules 204, axes X-Y are used. As shown, lenticules 204 are oriented to be perpendicular to the X-axis and parallel to the Y-axis. Significantly, using the lens web 200 made by the lenticular pattern-forming device of the present invention (i.e, a lens web 200 that is free from any non-lenticular or truncated lenticular regions), the interlaced image 302 having repeating interlaced image element 304 is in correspondence with the lens web. As shown, each of the lenticules has a length that is equal to the width W of the overall image web, while the length of the image web can include any desired number of lenticules. End use applications for the lenticular image web 300 include, but are clearly not limited to, wallpaper, signage, labels, and banners, among others.

A method of producing a web roll of lenticular lens is presented. A cylindrical housing is provided. The method further comprising providing a frame, a plurality of nip rollers mounted on the frame, and a cylindrical housing mounted on the frame, wherein the cylindrical housing is longitudinally disposed between the nip rollers to define a nip. The housing includes an outer surface having a circumferentially engraved groove pattern comprising longitudinally extending grooves. The grooves have substantially equal groove widths and are substantially parallel with the central longitudinal axis. The groove cover the surface of the housing. The method further comprises feeding a layer of plastic material through the nip such that the grooves are adapted for forming a lenticular pattern onto the layer of plastic material adjacent the outer surface of the housing to create a web of lenticular lens. The method also includes winding the web of lenticular lens into a web roll of lenticular lens.

The steps of making a lenticular lens as set forth in the above examples are provided for illustrative purposes. It is contemplated that other steps or selection parameters can be used with the above-identified equations. Other parameter and method selection sequences are considered to be encompassed by the present invention.

The present invention has been described in terms of preferred embodiments. Equivalents, alternatives, and modifications, aside from those expressly stated herein, are possible and should be understood to be within the scope of the appending claims.

What is claimed is:

1. A lenticular pattern-forming device comprising:
a housing rotatable about a central longitudinal axis, the housing including an outer surface having a groove pattern, the groove pattern including longitudinally extending grooves on the outer surface of the housing, the grooves having substantially equal groove widths, the grooves oriented substantially parallel with the central longitudinal axis; and
wherein the grooves cover the outer surface of the housing.

2. The lenticular device of claim 1 wherein the outer surface of the housing does not include a non-lenticular pattern-forming region.

3. The lenticular device of claim 1 wherein the outer surface of the housing does not include a truncated lenticular pattern-forming region.

4. The lenticular device of claim 1 wherein each of the grooves has an arcuate cross sectional surface.

5. The lenticular device of claim 1 wherein the grooves are engraved to create a lenticular lens material having predetermined lenses per inch designation.

6. The lenticular device of claim 1 wherein each of the grooves has a predetermined radius of curvature.

7. The lenticular device of claim 1 wherein each of the grooves has a constant internal radius of curvature.

8. The lenticular device of claim 7 wherein the grooves completely cover the outer surface of the housing.

9. The lenticular device of claim 1 wherein the housing comprises a nickel-phosphorous material.

10. A lenticular lens web roll comprising:
a lenticular lens web having a front surface and a substantially flat back surface opposing the front surface, the front surface having a plurality of lenticules formed thereon; and
wherein the plurality of lenticules are configured to be substantially parallel with a central longitudinal axis of the web roll; and
wherein the front surface is free from any non-lenticular or truncated lenticular regions.

11. The web roll of claim 10 further comprising an image joined to the flat back surface, thereby creating a lenticular image web.

12. The web roll of claim 10 wherein each of the lenticules has a focal length and wherein the lenticular lens web has a thickness that is substantially equal to the focal length of the lens so as to achieve a focused image.

13. The web roll of claim 10 wherein the lens web thickness is less than about 10 mils.

14. The web roll of claim 10 wherein each of the lenticules has a width of 0.00667 inches

15. The web roll of claim 10 wherein the lens web is made from a material selected from the group consisting of polyester, vinyl, polycarbonate, polyvinyl chloride, polyethylene terephthalate, and amorphous polyethylene terephthylene.

16. An engraved lenticular pattern-forming device comprising:
a housing rotatable about a central longitudinal axis, the housing including an outer surface having a circumferentially engraved groove pattern, the groove pattern including longitudinally extending grooves on the outer surface, the grooves having substantially equal groove widths, the longitudinally extending grooves are substantially parallel with the central longitudinal axis and wherein the grooves are adapted for forming a lenticular pattern onto a plastic layer to create a lenticular lens web having a front surface that is free from any non-lenticular or truncated lenticular regions.

17. The lenticular device of claim 16 wherein each of the grooves has an arcuate cross sectional surface.

18. The lenticular device of claim 16 wherein each of the grooves has a constant internal radius of curvature.

19. The lenticular device of claim 16 wherein the grooves are engraved to create a lenticular lens material having predetermined lenses per inch designation.

20. The lenticular device of claim 16 wherein each of the grooves has a predetermined radius of curvature.

21. The lenticular device of claim 16 wherein the housing includes an inner surface to receive a tubular body.

22. The lenticular device of claim 21 wherein the housing is mounted on a frame through the tubular body.

23. The lenticular device of claim 16 wherein the housing is cylindrical prior to the grooves being formed therein.

24. A system for making a lenticular lens, the system comprising:
a frame;
a plurality of nip rollers spaced apart from one another and mounted on the frame;
a housing longitudinally disposed between the nip rollers to define a nip, the housing including an outer surface having a circumferentially engraved groove pattern, the groove pattern including longitudinally extending grooves, the grooves having substantially equal groove widths, the longitudinally extending grooves substantially parallel with the central longitudinal axis; wherein the grooves cover the outer surface of the housing; and wherein a layer of plastic material is passed through the nip such that the grooves are adapted for forming a lenticular pattern onto a plastic layer to create a lenticular lens web having a front surface that is free from any non-lenticular or truncated lenticular regions.

25. The system of claim 24 wherein the outer surface of the housing does not include a truncated lenticular pattern-forming region.

26. The system of claim 24 wherein the housing is mounted on the frame through a tubular body.

27. The system of claim 26 wherein the tubular body receives cold fluid therethrough to cool the layer of plastic material.

28. The system of claim 24 wherein the grooves completely cover the outer surface of the housing.

29. The system of claim 24 wherein the outer surface of the housing does not include a non-lenticular pattern-forming region.

30. The system of claim 24 wherein each of the grooves has a predetermined radius of curvature.

31. The system of claim 24 wherein the lenticular lens web includes a front surface and a substantially flat back surface opposing the front surface and wherein the front surface includes the lenticular pattern formed by the groove pattern.

32. The system of claim 24 wherein the lenticular pattern includes series of lenticules and wherein each of the lenticules has a focal length and an arc angle.

33. The system of claim 24 wherein the layer of plastic is wound into a web roll such that the series of lenticules are configured to be substantially parallel with a central longitudinal axis of the web roll.

34. An lenticular pattern-forming device comprising:
a tubular body; and
a molding sleeve slidably positioned on the tubular body, the molding sleeve rotatable about a central longitudinal axis, the sleeve including an outer surface having a circumferentially engraved groove pattern, the groove pattern including longitudinally extending grooves, the grooves having substantially equal groove widths, the longitudinally extending grooves substantially parallel with the central longitudinal axis; and wherein the grooves cover the outer surface of the molding sleeve.

35. The lenticular device of claim 34 wherein the outer surface of the molding sleeve does not include any non-lenticular pattern-forming region.

36. The lenticular device of claim 34 wherein each of the grooves has a constant internal radius of curvature.

37. The lenticular device of claim 34 wherein the outer surface of the molding sleeve does not include a truncated lenticular pattern-forming region.

38. The lenticular device of claim 34 wherein the molding sleeve is mounted on a frame through the tubular body.

39. The lenticular device of claim 34 wherein the grooves completely cover the outer surface of the molding sleeve.

40. The lenticular device of claim 34 wherein the molding sleeve comprises a electro-deposited nickel-phosphorous composition.

41. A lenticular pattern-forming device comprising:
an enclosure rotatable about a central longitudinal axis, the enclosure having inner and outer surfaces, the outer surface having a circumferentially spaced groove pattern, the groove pattern including longitudinally extending grooves, the grooves having substantially equal groove widths, the longitudinally extending grooves substantially parallel with the central longitudinal axis, and wherein the grooves cover the outer surface of the enclosure.

42. The lenticular device of claim 41 wherein the enclosure includes an inner surface to receive a tubular body.

43. The lenticular device of claim 42 wherein the enclosure is mounted on a frame through the tubular body.

44. The lenticular device of claim 41 wherein the outer surface of the enclosure does not include a non-lenticular pattern-forming region.

45. The lenticular device of claim 41 wherein the outer surface of the enclosure does not include a truncated lenticular pattern-forming region.

46. The lenticular device of claim 42 wherein each of the grooves has a constant internal radius of curvature.

47. The lenticular device of claim 41 wherein the grooves completely cover the outer surface of the enclosure.

48. The lenticular device of claim 41 wherein the enclosure is a molding sleeve.

49. The lenticular device of claim 48 wherein the molding sleeve comprises a electro-deposited nickel-phoshorous composition.

50. The lenticular device of claim 48 wherein the molding sleeve is slidably positioned on the tubular body.

51. A method of producing a web roll of lenticular lens, the method comprising:
providing a cylindrical housing having an outer surface, the outer surface having a circumferentially engraved groove pattern, the groove pattern including longitudinally extending grooves, the grooves having substantially equal groove widths, the longitudinally extending grooves substantially parallel with the central longitudinal axis; and wherein the grooves cover the outer surface of the housing;
passing a layer of plastic material having a front surface and a substantially flat back surface adjacent the outer surface of the cylinder;
forming a lenticular pattern onto the front surface of the layer using the outer surface of the housing to create a web of lenticular lens; and
winding the web of lenticular lens into a web roll of lenticular lens.

52. The method of claim 51 further including providing a pair of nip rollers longitudinally disposed adjacent to the outer surface of housing to press the layer against the plurality of pattern-forming grooves.

53. The method of claim 51 wherein the step of passing the layer of plastic includes rotating the nip rollers in a first direction and rotating the cylindrical housing in an opposite second direction with respect to the nip rollers.

54. The method of claim 51 wherein the step of forming the lenticular pattern includes pressing the front surface of the layer against the outer surface of the cylindrical housing while the back surface remains flat.

55. The method of claim 51 wherein the step of winding the plastic layer includes rotating the plastic layer in a longitudinal axis of the layer.

56. A method of using a system for making a web roll of lenticular lens, the method comprising:
providing a frame, a plurality of nip rollers mounted on the frame, and a cylindrical housing mounted on the frame wherein the cylindrical housing is longitudinally disposed between the nip rollers to define a nip, the housing including an outer surface having a circumferentially engraved groove pattern, the groove pattern including longitudinally extending grooves, the grooves having substantially equal groove widths, the longitudinally extending grooves are substantially parallel with the central longitudinal axis; and wherein the grooves cover the outer surface of the housing;
feeding a layer of plastic material through the nip such that the grooves are adapted for forming a lenticular pattern onto the layer of plastic material adjacent the outer surface of the housing to create a web of lenticular lens; and
winding the web of lenticular lens into a web roll of lenticular lens.

57. The method of claim 56 wherein the layer of the plastic material includes a front surface and a substantially back surface, and wherein the step of feeding the plastic layer includes pressing the front surface of the plastic layer against the outer surface of the cylindrical housing while the back surface of the plastic layer remains flat.

58. A lenticular pattern-forming device comprising:
a housing rotatable about a central longitudinal axis, the housing including an outer surface having a circumferentially engraved groove pattern, the groove pattern including longitudinally extending grooves on the outer surface, the grooves having substantially equal groove widths, the longitudinally extending grooves substantially parallel with the central longitudinal axis; and
and wherein the grooves completely cover the outer surface of the housing.

59. A lenticular image web comprising:
a lenticular lens web having a length and a width, the web including a front surface having a plurality of lenticules formed thereon, the lenticules located opposite a substantially flat back surface and oriented such that they are parallel to a direction coinciding with the lens web width;
an interlaced image joined to the lens web, the image having a repeating interlaced image element;
wherein the lenticular lens web having the lenticules formed thereon is free from any non-lenticular or truncated lenticular regions.

60. The lenticular image web of claim 59 wherein the interlaced image is in correspondence with the lens web.

61. A lenticular lens web comprising:
a plastic layer having a length and a width, the web including a front surface having a plurality of lenticules formed thereon, the lenticules located opposite a substantially flat back surface and oriented such that the lenticules are parallel to a direction coinciding with the plastic layer width;
wherein the plastic layer having the plurality of lenticules formed thereon is free from any non-lenticular or truncated lenticular regions.
